(19) United States
(12) Patent Application Publication
(10) Pub. No.: US 2012/0206107 A1
(43) Pub. Date: Aug. 16, 2012

(54) PROTECTION MODULE AND METHOD FOR MANAGING STATUS DATA OF THE PROTECTION MODULE

(75) Inventors: Kimitoshi ONO, Tokyo (JP); Takahiro Saito, Tokyo (JP)

(73) Assignee: MITSUMI ELECTRIC CO., LTD., Tokyo (JP)

(21) Appl. No.: 13/360,870

(22) Filed: Jan. 30, 2012

(30) Foreign Application Priority Data
Feb. 14, 2011 (JP) 2011-029139

(51) Int. Cl. H02J 7/00; G06F 12/00

(52) U.S. Cl. 320/136; 711/154; 711/E12.001

(57) ABSTRACT

A protection module interposed between a chargeable/dischargeable secondary battery and a load, the protection module includes a first switching element connected to the chargeable/dischargeable secondary battery, a second switching element connected to the load, a protection unit configured to prevent over-charge and over-discharge of the chargeable/dischargeable secondary battery by switching on/off the first and the second switching elements, a storage unit configured to store status data of the chargeable/dischargeable secondary battery and threshold data pertaining to a status of the chargeable/dischargeable secondary battery, a status monitor unit configured to monitor the status of the chargeable/dischargeable secondary battery. The status monitor unit is configured to set plural storage areas in the storage unit and store the status data and a flag data indicating whether the status data is a latest status data in one of the plural storage areas.

### BACKGROUND OF THE INVENTION

1. Field of the Invention

The present invention generally relates to a protection module and a method for managing status data of the protection module.

2. Description of the Related Art

Secondary batteries such as a lithium ion secondary battery or a nickel hydrogen battery are known for supplying power to portable devices, charge circuits, and the like. The secondary battery may, for example, calculate the SOC (State of Charge) according to demand and control the charge/discharge of the secondary battery based on the calculated SOC. It is to be noted that the SOC indicates the proportion between the amount of charge being currently stored in the secondary battery and the capacity of the secondary battery (battery capacity).

In order to improve safety during the use of, for example, a portable device or a charging device that includes the secondary battery, there is a demand to monitor the status of the secondary battery. If the status of the secondary battery can be accurately monitored, it is possible to prompt the user to charge the secondary battery at an appropriate timing or to report the user of any abnormality in the secondary battery. Accordingly, it is desired to store status data (log data) into a storage unit (e.g., memory) during the time of charging/discharging of the secondary battery.

In a case where there is a disconnection (shut down) of power supply during the middle of writing (recording) data (e.g., log data) to a memory (e.g., rewritable memory), data that is being processed may be destroyed or erased. Accordingly, there is a known file system that retains data in the state immediately before starting to write the data, so that management data can be retained even when power is shut down during the writing process (see, for example, Japanese Laid-Open Patent Publication No. 2007-133535).

According to the method disclosed in Japanese Laid-Open Patent Publication No. 2007-133535, there is provided a data space in which data of a first file and data of a second file (which is a copy of the first file) are stored, a management space in which data indicating a storage location in a storage device is stored, and a flag data space in which flag data (data indicating which of the first and the second file is most recently written) is stored. With the configuration disclosed in Japanese Laid-Open Patent Publication No. 2007-133535, in a case of creating a new file, data pertaining to the location of the first and the second files are created in the management space, the first and the second files are created in the data space, and data indicating the most recently written file are stored in the flag data space.

Meanwhile, there are various types of log data stored in a storage device during the time of charging/discharging of the secondary battery. For example, the log data may be data pertaining to capacity retention rate, number of times of re-charge, charge/discharge time, number of cycles, or SOC. In recent years, there is also a demand for analyzing the status (e.g., degradation) of the secondary battery by using log data obtained plural times in the past.

However, with the method disclosed in Japanese Laid-Open Patent Publication No. 2007-133535, only the data of the first or the second file is recorded. Therefore, it is difficult to perform, for example, analysis using log data obtained plural times in the past by using the method disclosed in Japanese Laid-Open Patent Publication No. 2007-133535.

Further, log data stored during the time of charging/discharging of the secondary battery may be associated to plural other log data. In such a case, there may be a need to recover the plural log data at the same time. However, Japanese Laid-Open Patent Publication No. 2007-133535 does not disclose a method of associating plural log data to each other and appropriately recovering the associated plural log data.

### SUMMARY OF THE INVENTION

The present invention may provide a protection module and a method for managing status data of the protection module that substantially obviate one or more of the problems caused by the limitations and disadvantages of the related art.

Features and advantages of the present invention will be set forth in the description which follows, and in part will become apparent from the description and the accompanying drawings, or may be learned by practice of the invention according to the teachings provided in the description. Objects as well as other features and advantages of the present invention will be realized and attained by a protection module and a method for managing status data of the protection module particularly pointed out in the specification in such full, clear, concise, and exact terms as to enable a person having ordinary skill in the art to practice the invention.

To achieve these and other advantages and in accordance with the purpose of the invention, as embodied and broadly described herein, an embodiment of the present invention provides a protection module interposed between a chargeable/dischargeable secondary battery and a load, the protection module includes a first switching element connected to the chargeable/dischargeable secondary battery, a second switching element connected to the load, a protection unit configured to prevent over-charge and over-discharge of the chargeable/dischargeable secondary battery by switching on/off the first and the second switching elements, a storage unit configured to store status data of the chargeable/dischargeable secondary battery and threshold data pertaining to a status of the chargeable/dischargeable secondary battery, a status monitor unit configured to monitor the status of the chargeable/dischargeable secondary battery, wherein the status monitor unit is configured to set plural storage areas in the storage unit and store the status data and a flag data indicating whether the status data is a latest status data in one of the plural storage areas.

Other objects and further features of the present invention will be apparent from the following detailed description when read in conjunction with the accompanying drawings.

### BRIEF DESCRIPTION OF THE DRAWINGS

FIG. 1 is a schematic diagram illustrating a configuration of a protection module (monitor-function type protection module) according to an embodiment of the present invention;

FIG. 2 is a schematic diagram illustrating a function configuration of a CPU of a protection module according to an embodiment of the present invention;

FIGS. 3A and 3B are schematic diagrams illustrating examples of data stored in a rewritable non-volatile memory according to an embodiment of the present invention;

FIGS. 4A and 4B are schematic diagrams illustrating examples of log data according to an embodiment of the present invention;

FIG. 5 is a schematic diagram illustrating an example of a normal update log map list according to an embodiment of the present invention;

FIGS. 6A-6C are schematic diagrams illustrating examples of log writing (recording) formats according to an embodiment of the present invention;

FIG. 7 is a state-transition diagram in a case of storing log data in a memory according to an embodiment of the present invention; and

FIG. 8 is a flowchart illustrating an example of an operation for managing status data according to an embodiment of the present invention

### DESCRIPTION OF THE PREFERRED EMBODIMENTS

A protection module 100 according to an embodiment of the present invention is connected between, for example, a chargeable/dischargeable secondary battery 200 and a load 300 (e.g., portable device, charge circuit). That is, the protection module 100 is connected to the secondary battery 200 on one side and to the load 300 on the other side. The protection module 100 includes a status monitor unit 117 having functions such as monitoring the charging and discharging of the secondary battery 200 and managing log data pertaining to the charging and discharging of the secondary battery 200. As described below, the status monitor unit 117 is also referred to as “CPU 117”. Accordingly, the protection module 100 is hereinafter also referred to as “monitor function type protection module 100”). As described below, even in a case where status data (log data) pertaining to the secondary battery 200 is damaged or erased during a process of recording the status data (log data) pertaining to the secondary battery 200 in a storage unit (e.g., rewritable non-volatile memory) 122 of the protection module 100, the status monitor unit 117 can recover the damaged or erased data. Accordingly, with the protection module 100, the status data pertaining to the secondary battery 200 can be managed with high precision.

For example, with the protection module 100, the monitor function unit 117 prepares (allocates) plural storage areas (in this example, storage areas A and B) in the storage unit 122 with respect to a single target log data to be recorded in the storage unit 122. In a case of recording (updating) the target log data, the storage areas A and B are used alternately. For example, only the storage area A is used in a case of recording the target log data for the first time, only the storage area B is used in a case of recording the target log data for the second time, only the storage area A is used in a case of recording the target log data for the third time, and only the storage area B is used in a case of recording the target log data for the fourth time. Thereby, the latest (newest) target log data is alternately recorded (updated) in the storage areas A and B. There are various types of log data (status data) pertaining to, for example, capacity retention rate, number of times of recharging the secondary battery, time of charging/discharging, number of cycles, SOC, temperature). In a case of recording the log data, the various types of log data are stored separately in accordance with the type of log data.

As described above, plural storage areas (in this example, two storage areas) are prepared (allocated) for recording a single target log data, and the target log data is alternately stored in the storage area A and the storage area B. Thus, in a case where there is a limit in the number of times of recording data in the physical memory, it appears that the number of times in which the target log data can be rewritten is doubled.

Further, with the protection module 100, even in a case where log data stored in one of the storage areas A and B is determined to be abnormal (e.g., due to damage of data), normal log data stored in the other one of the storage areas A and B can be used to recover the abnormal log data. As described below, the recovery of log data can be performed with respect to each type of log data or a group of log data including plural types of log data.

As another example, the monitor function unit 117 may prepare (allocate) three or more storage areas (in this example, storage areas A, B, and C) in the storage unit 122 with respect to a single target log data to be recorded in the storage unit 122. In a case of recording (updating) the target log data, the target log data is recorded in storage area A, B, or C in a cycle based on a predetermined criterion (e.g., chronological order). Thereby, log data of the past (i.e. past log data) can be stored in the storage unit 122 for a number of times. Accordingly, analysis of, for example, degradation of the secondary battery 200 can be performed with high precision by referring to the past log data stored in the storage unit 122.

In the following, the protection module 100 and a method for managing status data of the protection module 100 according to embodiments of the present invention are described in further detail with reference to the accompanying drawings. As described above, the protection module 100 includes a status monitor unit 117 having functions such as monitoring charge/discharge of the secondary battery 200 and managing log data pertaining to the charge/discharge of the secondary battery 200. It is to be noted that the protection module of the present invention is not limited to the monitor function type protection module having such functions.

### <Configuration of Protection Module>

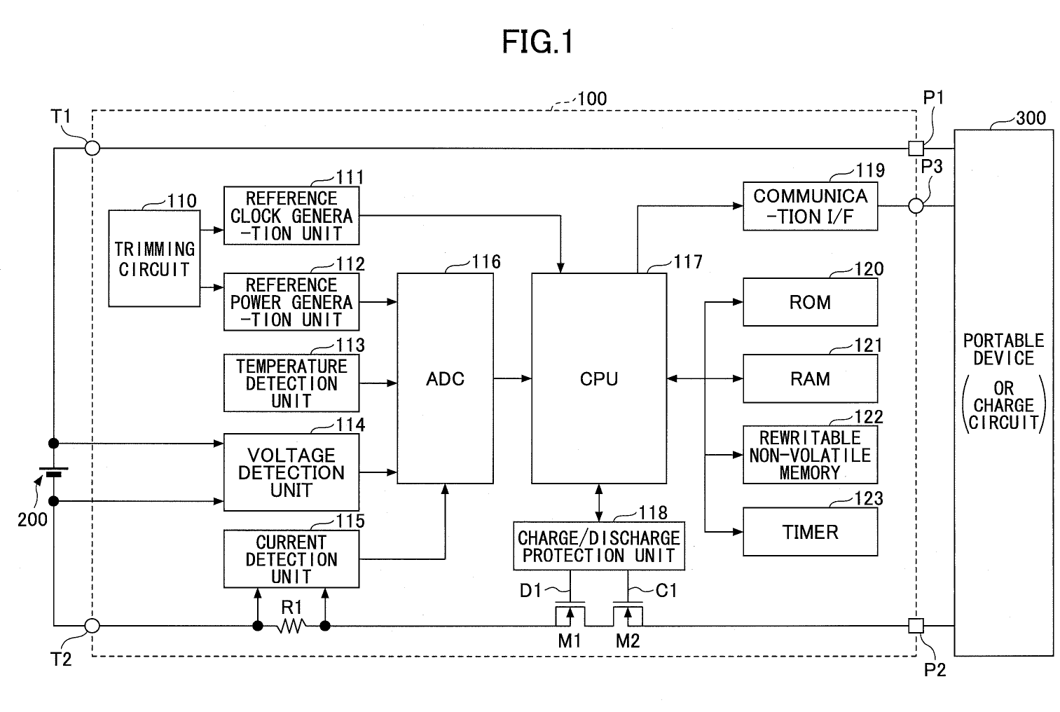

First, a monitor-function type protection module 100 according to an embodiment of the present invention is described with reference to the accompanying drawings. FIG. 1 is a schematic diagram illustrating a configuration of the monitor-function type protection module 100 (hereinafter simply referred to as “protection module 100”) according to an embodiment of the present invention. The protection module 100 illustrated in FIG. 1 is connected between the secondary battery 200 serving as a power source and the portable device 300 serving as a load. It is to be noted that the protection module 100 according to the embodiment of the present invention is not limited to the configuration illustrated in FIG. 1. For example, the portable device 300 connected to the protection module 100 may be replaced with a charge circuit.

In the protection module 100, a terminal T1 is connected to a cathode of the secondary battery 200, and a terminal T2 is connected to an anode of the secondary battery 200. Further, in the protection module 100, a terminal P1 is connected to a cathode of the portable device 300, and a terminal P2 is connected to an anode of the portable device 300. Further, in the protection module 100, a terminal P3 is a communication terminal for transmitting/receiving various data with respect to the portable device 300.

The protection module 100 according to an embodiment of the present invention includes, for example, a trimming circuit 110, a reference clock generation unit 111, a reference power generation unit 112, a temperature detection unit 113, a voltage detection unit 114, a current detection unit 115, an ADC (Analog to Digital Converter) 116, the CPU (Central Processing Unit) 117, a charge/discharge protection unit 118, a communication I/F (Interface) 119, a ROM (Read Only Memory) 120, a RAM (Random Access Memory) 121, a rewritable non-volatile memory 122, and a timer 123. Further, protection module 100 includes a resistor R1, a transistor M1, and a transistor M2 that are connected between the terminal T2 and the terminal P2.

The trimming circuit 110 controls a frequency of an internal clock signal by outputting a clock frequency control signal to the reference clock generation unit 111 in accordance with a control signal from the CPU 117. Further, the trimming circuit 110 sets a voltage level of a voltage output from the reference power generation unit 112 by outputting a voltage control signal to the reference power generation unit 112 in accordance with a control signal from the CPU 117.

The reference clock generation unit 111 generates a reference clock signal for the inside of the protection module 100 (i.e. internal reference clock signal of the protection module 100) based on the clock frequency control signal from the trimming circuit 110 and outputs the generated reference clock signal to the CPU 117.

The reference power generation unit 112 sets the voltage level inside the protection module 100 in accordance with the voltage control signal from the trimming circuit 110 and outputs a voltage of the set voltage level to the ADC 116.

The temperature detection unit 113 detects the temperature of the secondary battery 200 and outputs the detected temperature to the ADC 116. The voltage detection unit 114 detects an output voltage of the secondary battery 200 via a voltage detection terminal connected to the anode and the cathode of the secondary battery 200 and outputs the value of the detected voltage to the ADC 116. The current detection unit 115 detects the current flowing through a resistor R1 dedicated for current detection (i.e. charge/discharge current of the secondary battery 200) via a current detection terminal connected to both ends of the resistor R and outputs the value of the detected current to the ADC 116.

The ADC 116 uses the reference voltage obtained from the reference voltage generation unit 112 and converts the signals (data) output from the temperature detection unit 113, the voltage detection unit 114, and the current detection unit 115 from analog data to digital data. Further, the ADC 116 outputs the converted digital data to the CPU 117.

As described below, the CPU 117 according to an embodiment of the present invention has a function of a status monitoring unit that monitors the status of the secondary battery 200. For example, based on various outputs received from various units of the protection module 100 (e.g., the temperature detection unit 113, the voltage detection unit 114, the current detection unit 115), the CPU 117 calculates the voltage of the secondary battery 200, calculates the charge/discharge current of the secondary battery 200, calculates remaining charge capacity of the secondary battery 200, detects the status of the secondary battery 200, and controls storage/management/recovery of status data (log data) stored during charge/discharge of the secondary battery 200 or during load release of the secondary battery 200. Details of the functions of the CPU 117 are described below.

The charge/discharge protection unit 118 protects the secondary battery 200 from over-charge or over-discharge by controlling the on and off of the transistors M1, M2 serving as switching devices. The charge/discharge protection unit 118 includes the terminals D1, C1 connected to the gates of the transistors M1, M2, respectively. The charge/discharge protection unit 118 disconnects the transistor M1 by outputting a low level signal from the terminal D1 when over-discharge or over-current of the secondary battery 200 is detected. The charge/discharge protection unit 118 disconnects the transistor M2 by outputting a low level signal from the terminal C1 when over-charge of the secondary battery 200 is detected by an over-charge detection unit (not illustrated). It is to be noted that the charge/discharge protection unit 118 of this embodiment may control the switching on/off of the transistors M1, M2 in accordance with instructions from the CPU 117.

The communication I/F 119 performs communications with the portable device 300 via the terminal P3. The ROM 120 stores a program(s) executed for achieving the functions of the CPU 117. The RAM 120 temporarily stores, for example, data pertaining to process results of the CPU 117.

The rewritable non-volatile memory 122 stores, for example, the temperature detected by the temperature detection unit 113, the value of the voltage detected by the voltage detection unit 114, and the value of the current detected by the current detection unit 115. Further, the rewritable non-volatile memory 122 stores the status data (log data) stored during charge/discharge of the secondary battery 200 or during load release of the secondary battery 200. Further, the rewritable non-volatile memory 122 stores various threshold data that are referred for determining the status of the secondary battery 200. Even in a case where power supply from the secondary battery 200 is cut off, the rewritable non-volatile memory 122 retains data already stored therein. The rewritable non-volatile memory 122 is, for example, an EPROM (Erasable Programmable ROM).

The timer 123 manages the time of the entire operations of the protection module 100. The timer 123 counts a system clock. The value of the counted system clock is referred by the CPU 117. For example, the timer 123 stores time data used when storing data (e.g., voltage calculation results, current calculation results) into the memory 122 or the like and manages elapsed time (e.g., the time elapsed from starting a charging process, the time elapsed from starting a discharge process).

The secondary battery 200 may be, for example, a lithium ion battery, a nickel hydrogen battery, or an electric double-layer capacitor. The secondary battery 200 is the power source for both the portable device 300 and the protection module 100. The temperature detection unit 113, the voltage detection unit 114, and the current detection unit 115 may require supply of power from the secondary battery 200 depending on the configuration of the temperature detection unit 113, the voltage detection unit 114, and the current detection unit 115. The temperature detection unit 113, the voltage detection unit 114, the current detection unit 115, the ADC 116, and the CPU 117 function as a status detection unit for detecting the battery status of the secondary battery 200.

Further, the portable device 300 connected to the protection module 100 may be, for example, an external electronic device that can be carried by a user. More specifically, the portable device 300 may be, for example, a portable phone, a portable data terminal (e.g., a PDA (Personal Digital Assistant), a laptop personal computer), a digital camera, a portable game device, a portable music/video player (e.g., DVD (Digital Versatile Disc) player), an electric appliance, a POS (Point of Sales) terminal, or a wireless device.

The protection module 100 may be mounted inside or outside the portable device 300. Based on battery status data of the secondary battery 200 obtained from the communication I/F 119, the portable device 300 performs a predetermined operation corresponding to the battery status data of the secondary battery 200. The portable device 300 displays the battery status data (e.g., charge amount data, degradation data, or replacement timing data pertaining to the secondary battery 200) on a display part thereof. Further, the portable device 300 may change the operation mode of the portable device itself 300 from, for example, a “normal power consumption mode” to “low power consumption mode” according to the battery status data.

### <Functions of CPU>

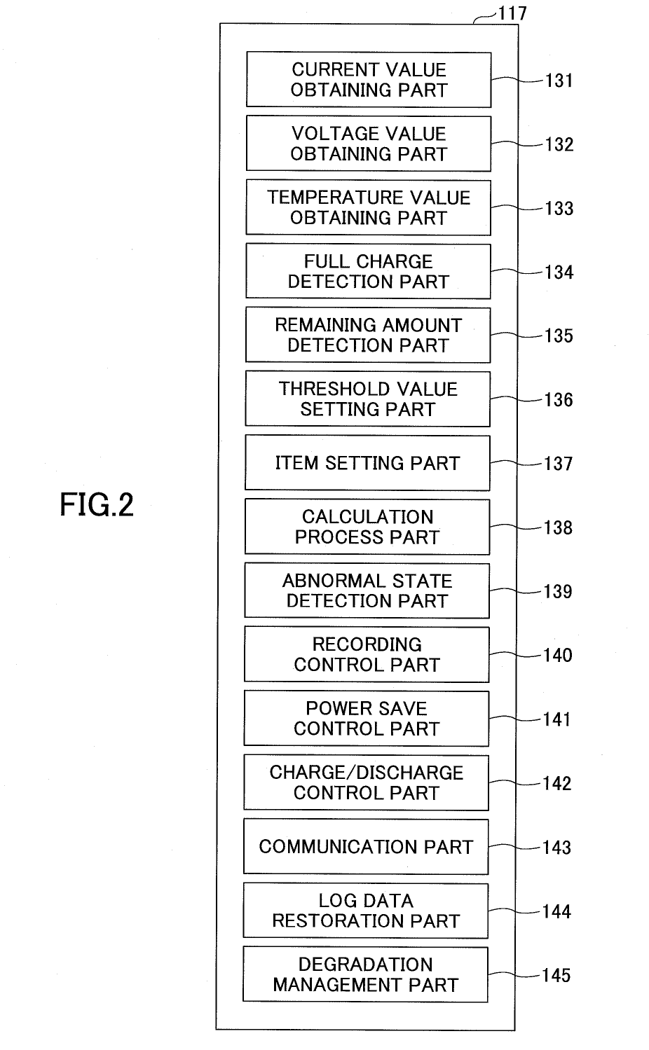

Next, the functions of the CPU 117 according to an embodiment of the present invention are described with reference to FIG. 2. FIG. 2 is a schematic diagram illustrating a function configuration of the CPU 117 of the protection module 100 according to an embodiment of the present invention.

As illustrated in FIG. 2, the CPU 117 includes function configuration parts, such as, a current value obtaining part 131, a voltage value obtaining part 132, a temperature value obtaining part 133, a full charge detection part 134, a remaining amount detection part 135, a threshold value setting part 136, an item setting part 137, a calculation process part 138, an abnormal state detection part 139, a recording control part 140, a power save control part 141, a charge/discharge control part 142, a communication part 143, a log data restoration part 144, and a degradation management part 145.

The current value obtaining part 131 obtains the value of the current detected by the current detection unit 115. The voltage value obtaining part 132 obtains the value of the voltage detected by the voltage detection unit 114. The temperature value obtaining part 133 obtains the value of the temperature detected by the temperature detection unit 113.

The full charge detection part 134 detects whether the secondary battery 200 is fully charged (full charge) based on, for example, the current value obtained by the current value obtaining part 131 and the voltage value obtained by the voltage value obtaining part 132. For example, the full charge detection part 134 calculates a full charge capacity of the secondary battery 200 based on the voltage value obtained immediately before the starting of a charging process (open circuit voltage) and the voltage value obtained after a predetermined time elapsed from the completion of the charging process. In other words, the full charge detection part 134 calculates a charging rate immediately before the starting of a charging process based on the voltage value obtained immediately before the starting of the charging process and a predetermined characteristic “open circuit voltage−charging rate” and calculates a charging rate after a predetermined time elapsed from the completion of the charging process based on the voltage value obtained after the predetermined time elapsed from the completion of the charging process and the predetermined characteristic “open circuit voltage−charging rate”.

Then, the full charge detection part 134 calculates the full charge capacity FCC of the secondary battery 200 based on the following arithmetic expression (1) wherein “FCC” [mAh] indicates the full charge capacity, “SOC1” [%] indicates the charging rate immediately before the starting of the charging process, “SOC2” [%] indicates the charging rate after a predetermined time elapsed from the completion of the charging process, and “Q” [mAh] indicates the amount of electric charge (electrical quantity) charged during a charging period from the time of starting the charging process to the time of completing the charging process.

FCC=Q/{(SOC2−SOC1)/100} [Expression (1)]

In a case where temperature is corrected, SOC1 and SOC2 can be calculated more accurately. Further, by referring to battery voltage obtained after a predetermined time elapsed from the completion of the charging process, calculation can be performed more accurately because the battery voltage is more stable than the voltage obtained at the time of the completion of the charging process.

The remaining amount detection part 135 detects the amount of charge remaining in the secondary battery 200 (remain data) based on, for example, the current value obtained by the current value obtaining part 131 or the voltage value obtained by the voltage value obtaining part 132.

For example, the remaining amount detection part 135 may use the above-described charging rate and the full charge capacity and calculate the remaining charge amount of the secondary battery 200 with an equation of “remaining amount=full charge capacity×charging rate”.

The threshold value setting part 136 selects and sets threshold values used for, for example, detecting an abnormal state based on the below-described threshold data 500 stored in the rewritable non-volatile memory 122.

The item setting part 137 sets, for example, status items (which are obtained as log data), the number of storage areas corresponding to a data item to be recorded, and a group of log data. The item setting part 137 also sets items of data used for monitoring the status of the secondary battery 200 based on status data (log data) recorded in the rewritable non-volatile memory 122.

It is to be noted that the threshold values set by the threshold value setting part 136 and the items set by the item setting part 137 can be selected in accordance with, for example, instructions from the portable device 300.

The calculation process part 138 performs various calculations for obtaining status data by using, for example, the current value obtained by the current value obtaining part 131, the voltage value obtained by the voltage value obtaining part 132, the temperature value obtained by the temperature value obtaining part 133, and the remaining charge amount detected by the remaining amount detection part 135.

The abnormal state detection part 139 detects abnormality in a case where data recorded in the rewritable non-volatile memory 122 is destroyed due to, for example, power supply being shut off during recording of log data. As for the cause of the power supply being shut off during recording of log data, there is, for example, striking of lightning, internal short-circuiting, occurring of power failure, or a human-induced operation (e.g., switching off of power).

The abnormal state detection part 139 can determine whether the status of the secondary battery 200 is abnormal due to degradation or the like based on the status data obtained by the calculation process part 138 and the threshold value set by the threshold setting part 136 and recorded in the rewritable non-volatile memory 122. In this embodiment, the abnormal state detection part 139 determines whether the status of the secondary battery 299 is abnormal when temperature increases by charging or over-discharging of the secondary battery 200, when the secondary battery 200 is left in a high temperature state for a long time, when temperature becomes abnormal during discharge (e.g., when using the portable device 300), when there is a time out of the charging process, or when the full charge capacity is larger than the sum of the remaining charge amount and the charge amount.

The recording control part 140 stores (records) log data obtained from the above-described function configuration parts into, for example, one of the plural areas provided in the rewritable non-volatile memory 122. The data to be recorded in the rewritable non-volatile memory 122 includes, for example, current value, voltage value, temperature, SOC, number of times of detecting various occurrences, time of detecting various occurrences, various status data calculated by the calculation process part 138, time of detecting an abnormal state by the abnormal state detection part, and the number of times the abnormal state is detected by the abnormal state detection part.

The recording control part 140 sets a flag indicating the latest (newest) log data with respect to each log data or each log data group including various predetermined log data items when recording normal log data.

The power save control part 141 switches the protection module 100 to a power save mode based on, for example, calculation results of the calculation process part 138 and detection results of the abnormal state detection part 139.

The charge/discharge control part 142 provides instructions pertaining to, for example, over-charge and over-discharge to the charge/discharge protection unit 118 based on, for example, calculation results of the calculation process part 138 and detection results of the abnormal state detection part 139.

The communication part 143 reports various data to the portable device 300 in a case where the full charge detection part 134 detects a full charge state of the secondary battery 200 or a case where the abnormal state detection part 139 detects an abnormality in the secondary battery 200.

In a case where an abnormality is detected during recording of log data by the abnormal state detection part 139, the log data restoration part 144 restores log data based on log data recorded immediately before the detection of the abnormality by the recording control part 140. For example, the log data restoration part 144 builds the latest (newest) normal log data based on the flag data set with respect to each normal log data or each normal log data group updated immediately before the detection of the abnormality.

The degradation management part 145 obtains the degree of degradation (degradation degree) of the secondary battery 200 based on history data of, for example, status data (log data) recorded in the rewritable non-volatile memory 122 by the recording control part 140. For example, the degradation management part 145 compares the number of times of charging, the number of cycles of charging/discharging, the total time of charging, and the capacity retention rate with corresponding predetermined threshold values and determines the degradation degree based, on the comparison results. In a case where the degradation degree surpasses a predetermined threshold, the degradation management part 145 reports the degradation degree of the secondary battery 200 to the portable device 300 via the communication part 143.

Hence, the CPU 117 according to an embodiment of the present invention functions as a status monitoring unit that monitors the status of the secondary battery 200 by using the functions of the above-described function configuration parts. The CPU 117 functioning as the status monitoring unit sets plural areas in the rewritable non-volatile memory (storage unit) 122 for storing, for example, status data during charging/discharging of the secondary battery 200 and stores status data and flag data (data indicating which of the status data is the latest (newest) recorded status data) into one of the plural areas of the rewritable non-volatile memory 122. It is to be noted that the status data to be stored in the rewritable non-volatile memory 122 is not limited to the status data obtained during charging/discharging. For example, status data during load release may be stored in accordance with conditions of abnormality in view of the possibility of temperature abnormality occurring during load release of the secondary battery 200.

The CPU 117 can set flag data with respect to a status item selected from plural status items included in the status data. Further, the selected status item may be constituted of plural groups, so that the CPU 117 can set flag data with respect to each group of the selected status item.

In this embodiment, the plural areas of the rewritable non-volatile memory 122 set by the CPU 117 may be 3 or more areas. In a case where there are 3 or more areas, the CPU 117 can obtain status data (log data) in time series (time series status data) from the 3 or more areas and extract error among the 3 or more areas based on, for example, difference data of the time series status data. Further, the CPU 117 can obtain the degradation degree of the secondary battery 200 by referring to, for example, the extracted error and the number of times of charging/discharging of the secondary battery 200.

Accordingly, with the above-described embodiment of the present invention, status data of the protection module 100 can be managed with high precision.

### <Data Stored in Rewritable Non-Volatile Memory>

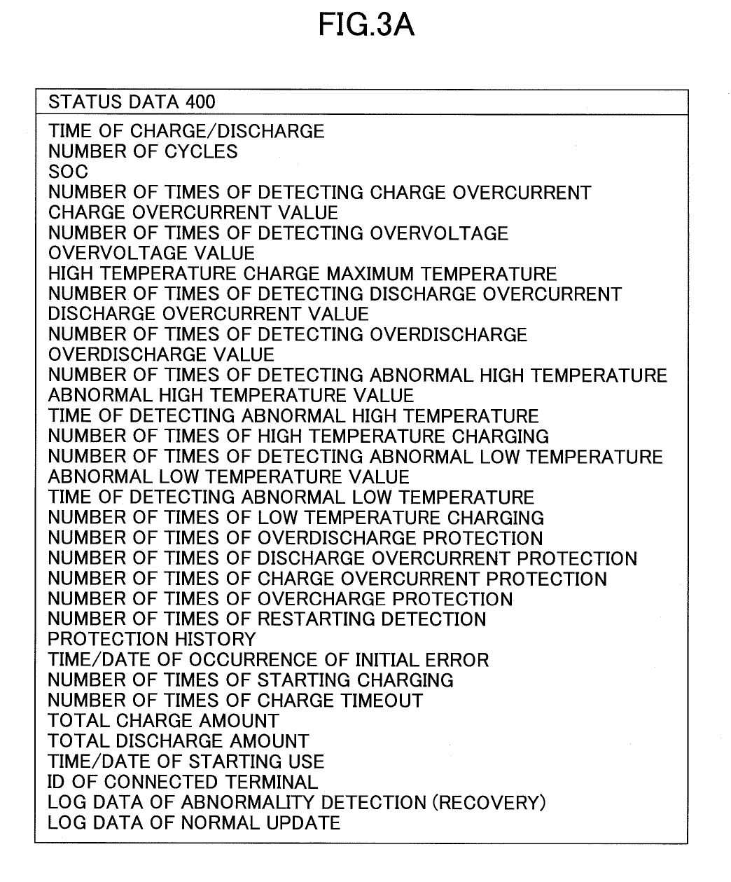

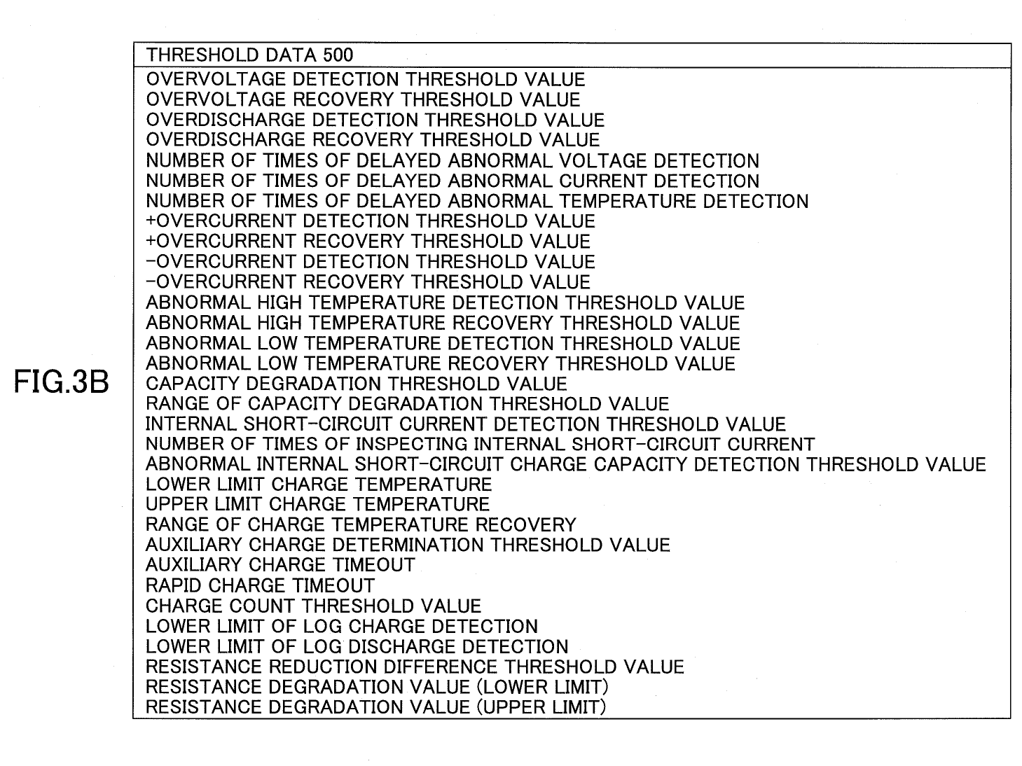

Next, examples of the data stored in the rewritable non-volatile memory 122 according to an embodiment of the present invention are described with reference to FIGS. 3A and 3B. FIGS. 3A and 3B are schematic diagrams illustrating examples of the data stored in the rewritable non-volatile memory 122 according to an embodiment of the present invention. Various data pertaining to the status of the secondary battery 200 are stored (recorded) in the rewritable non-volatile memory 122. For example, the rewritable non-volatile memory 122 stores status data (including log data) 400 as illustrated in FIG. 3A and threshold data 500 as illustrated in FIG. 3B.

FIG. 3A illustrates examples of the items of status data 400, that is, data pertaining to the status of the secondary battery 200 according to an embodiment of the present invention. The rewritable non-volatile memory 122 stores the items of the status data 400 as illustrated in FIG. 3A. As illustrated in FIG. 3A, the items included the status data 400 may be, for example, time of charge/discharge, number of cycles, SOC, number of times of detecting charge overcurrent, charge overcurrent value, number of times of detecting overvoltage, overvoltage value, high temperature charge maximum temperature, number of times of detecting discharge overcurrent, discharge overcurrent value, number of times of detecting overdischarge, overdischarge value, number of times of detecting abnormal high temperature, abnormal high temperature value, time of detecting abnormal high temperature, number of times of high temperature charging, number of times of detecting abnormal low temperature, abnormal low temperature value, time of detecting abnormal low temperature, number of times of low temperature charging, number of times of overdischarge protection, number of times of discharge overcurrent protection, number of times of charge overcurrent protection, number of times of overcharge protection, number of times of re-start detection, protection history, time/date of occurrence of initial error, number of times of starting charging, number of times of charge timeout, total charge amount, total discharge amount, time/date of starting use, ID of connected terminal, log data of abnormal detection (recovery), and log data of normal update. It is to be noted that the types or the order of the items of the status data 400 are not limited to those illustrated in FIG. 3A.

Further, an ID (identification data) of a terminal (e.g., portable device 300) connected to the secondary battery 200 is also included in the status data 400. The monitor function type protection module 100 according to an embodiment of the present invention communicates with the portable device 300 with the communication part 143 and obtains the ID of the portable device 300. The recording control part 140 records the obtained ID in the rewritable non-volatile memory 122.

By recording the ID in the rewritable non-volatile memory 122, the portable device 300 connected to the secondary battery 200 can be identified in a case where an abnormality is detected in the secondary battery 200. Further, the status data 400 can be recorded and managed in correspondence with the ID of each portable device 300.

As illustrated in FIG. 3A, the status data 400 includes various values and data such as “charge overcurrent value” indicating the current value when overcurrent is detected during a charging process, “number of times of detecting charge overcurrent” indicating the number of times of detecting overcurrent during a charging process, “overvoltage value” indicating the voltage value when overvoltage is detected, and “number of times of detecting overvoltage” indicating the number of times of detecting overvoltage.

The items “log data of abnormal detection (recovery)” and “log data of normal update” included in the status data 400 are described below.

FIG. 3B illustrates examples of threshold values of threshold data 500, that is, data used by the abnormal state detection part 139 for detecting an abnormal state of the secondary battery 200 according to an embodiment of the present invention. The rewritable non-volatile memory 122 stores the threshold values of the threshold data 500 as illustrated in FIG. 3B. As illustrated in FIG. 3B, the threshold values included the threshold data 500 may be, for example, overvoltage detection threshold value, overvoltage recovery threshold value, overdischarge detection threshold value, overdischarge recovery threshold value, number of times of delayed abnormal voltage detection, number of times of delayed abnormal current detection, number of times of delayed abnormal temperature detection, +overcurrent detection threshold value, +overcurrent recovery threshold value, −overcurrent detection threshold value, −overcurrent recovery threshold value, abnormal high temperature detection threshold value, abnormal high temperature recovery threshold value, abnormal low temperature detection threshold value, abnormal low temperature detection threshold value, capacity degradation threshold value, range of capacity degradation threshold value, internal short-circuit current detection threshold value, number of times of inspecting internal short-circuit current, abnormal internal short-circuit charge capacity detection threshold value, lower limit charge temperature, upper limit charge temperature, range of charge temperature recovery, auxiliary charge determination threshold value, auxiliary charge timeout, rapid charge timeout, charge count threshold value, lower limit of log charge detection, lower limit of log discharge detection, resistance reduction difference threshold value, resistance degradation value (lower limit), and resistance degradation value (upper limit). It is to be noted that the types or the order of the items of the threshold data 500 are not limited to those illustrated in FIG. 3B.

As illustrated in FIG. 3B, the threshold data 500 includes various threshold values for detecting abnormality of the secondary battery 200 such as “overvoltage detection threshold value” used for detecting overvoltage of the secondary battery 200, “overdischarge detection threshold value” used for detecting overdischarge of the secondary battery 200, “number of times of delayed abnormal voltage detection” used for determining abnormality of the voltage value when an abnormal value is consecutively detected for a predetermined number of times, and “number of times of delayed abnormal current detection” used for determining abnormality of the current value when an abnormal value is consecutively detected for a predetermined number of times.

With the monitor function type protection module 100 according to an embodiment of the present invention, the threshold setting part 136 selects and sets thresholds values used by the abnormal state detection part 139 for detecting an abnormal state of the secondary battery 200 and threshold values used by the calculation process part 138 for performing calculation.

Accordingly, with the monitor function type protection module 100 according to an embodiment of the present invention, an item(s) in the status data 400 and a threshold value(s) in the threshold data 500 that are to be used for detecting the status of the secondary battery 200 can be set in accordance with a particular status (status item) of the secondary battery 200 desired to be detected. That is, with the monitor function type protection module 100 according to an embodiment of the present invention, a status (status item) of the secondary battery 200 desired to be detected can be selected in accordance with the status (condition) of the portable device 300 connected to the secondary battery 200. Thereby, the status of the secondary battery 200 can be monitored in accordance with various conditions of use.

The threshold data 500 is often different depending on, for example, the type of the portable device 300 or the manufacturer of the portable device 300. However, because the threshold data 500 is stored in the rewritable non-volatile memory 122, the threshold data 500 can be easily written and rewritten to the rewritable non-volatile memory 122. Accordingly, the protection module 100 can be used regardless of the type or manufacturer of the portable device 300.

As described above, the protection module 100 according to an embodiment of the present invention can record the status data 400 indicating the status and history of the secondary battery 200 (e.g., status of use of the secondary battery 200, status of degradation of the secondary battery 200) in the rewritable non-volatile memory 122. Therefore, with the protection module 100 according to an embodiment of the present invention, the data pertaining to the status and history of the secondary battery 200 can be read out from the portable device 300 for analyzing, for example, the status of use of the secondary battery 200.

Further, as described above, the protection module 100 according to an embodiment of the present invention can record the threshold data 500 indicating parameters for determining the status of the secondary battery 200 (e.g., parameter for determining abnormality of the secondary battery 200) in the rewritable non-volatile memory 122. Accordingly, one or more threshold values can be arbitrarily selected from the threshold values in the threshold data 500. Thereby, the protection module 100 according to an embodiment of the present invention can determine whether various status items of the secondary battery 200 are abnormal or normal by referring to the threshold values selected from the threshold data 500.

Further, as described above, the protection module 100 according to an embodiment of the present invention not only records items of the secondary battery 200 that are in a normal state but also items of the secondary battery 200 that are in an abnormal state. Moreover, the protection module 100 records data indicating, for example, detection of an abnormal state, an item during an abnormal state, the number of times an abnormal state is detected. Therefore, the protection module 100 according to an embodiment of the present invention can monitor the status of the secondary battery 200 under various conditions of use.

### <Log Data of Abnormal Detection (Recovery) and Log Data of Normal Update>

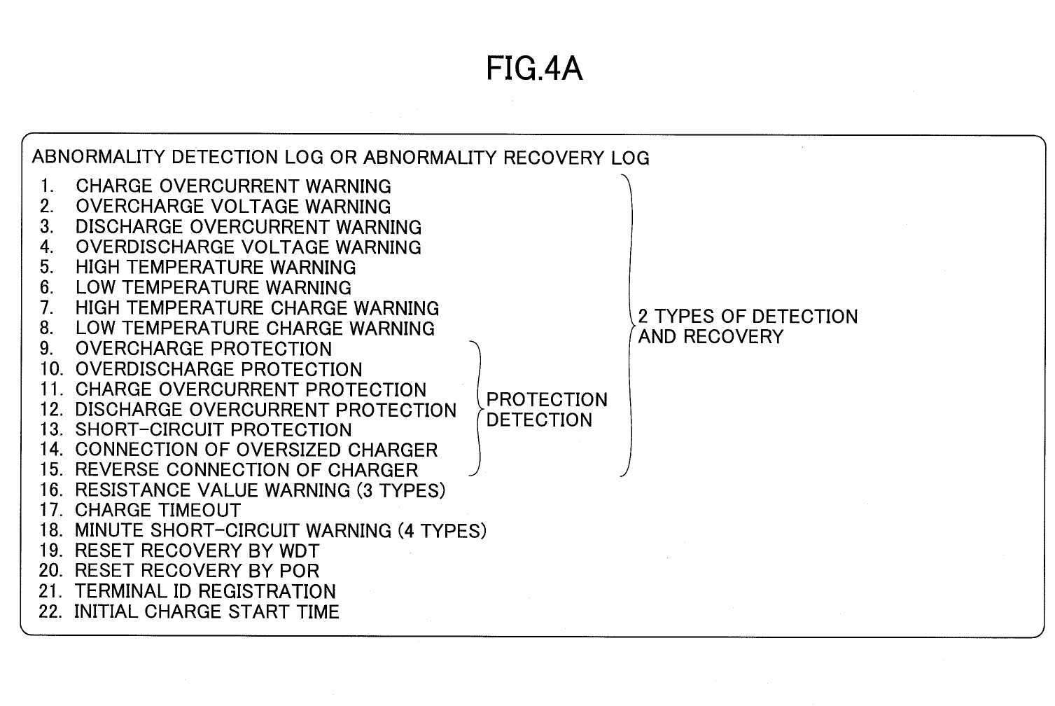

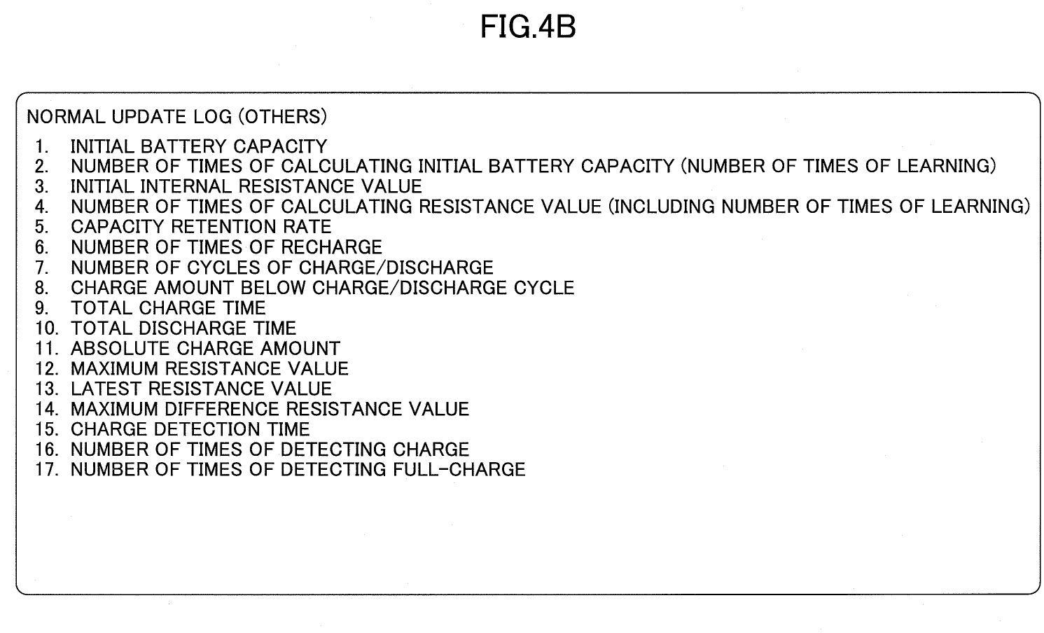

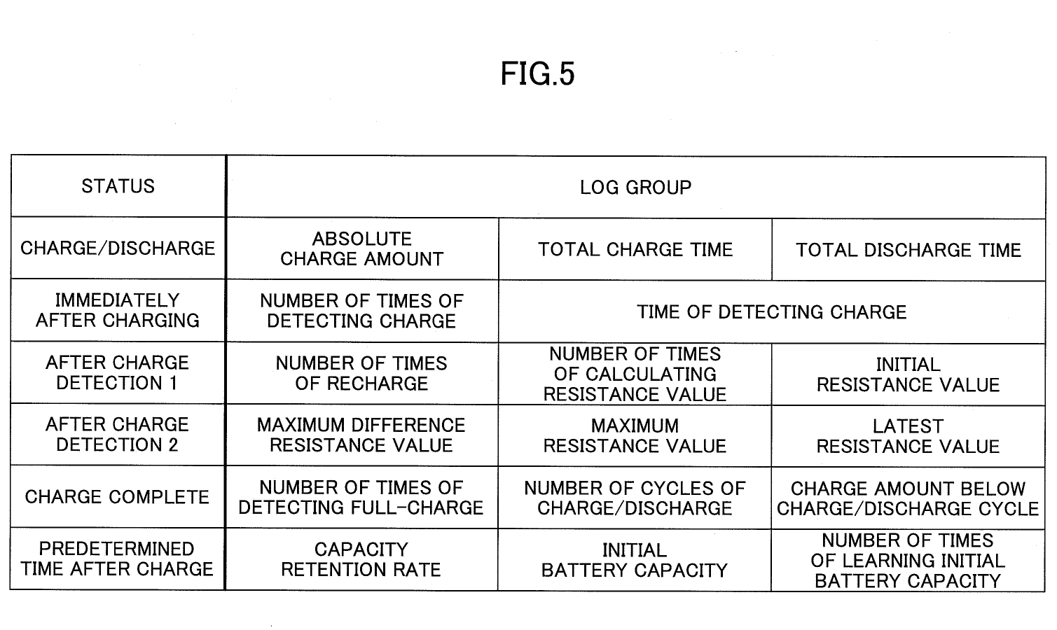

Next, details the log data of abnormal detection (recovery) and the log data of normal update included in the status data 400 are described below with reference to FIG. 4. FIGS. 4A and 4B are schematic diagrams for describing the log data of abnormal detection (recovery) and the log data of normal update. FIG. 4A is a schematic diagram illustrating examples of data items included in the log data of abnormal detection (recovery) according to an embodiment of the present invention. FIG. 4B is a schematic diagram illustrating examples of data items included in the log data of normal update according to an embodiment of the present invention. FIG. 5 illustrates an example of a list indicating a normal update log map according to an embodiment of the present invention.

The data items included in the log data of abnormal detection (recovery) illustrated in FIG. 4A include, for example, “1. charge overcurrent warning”, “2. overcharge voltage warning”, “3. discharge overcurrent warning”, “4. overdischarge voltage warning”, “5. high temperature warning”, “6. low temperature warning”, “7. high temperature charge warning”, “8. low temperature charge warning”, “9. overcharge protection”, “10. overdischarge protection”, “11. charge overcurrent protection”, “12. discharge overcurrent protection”, “13. short-circuit protection”, “14. connection of oversized charger”, “15. reverse connection of charger”, “16. resistance value warning (3 types)”, “17. charge timeout”, “18. minute short-circuit warning (4 types)”, “19. reset recovery by WDT (Watch Dog Timer)”, “20. reset recovery by POR (Power On Reset)”, “21. terminal ID registration”, and “22. initial charge start time”. It is to be noted that the types or the order of the data items of the log data of abnormal detection (recovery) are not limited to those illustrated in FIG. 4A.

It is to be noted that the data items 1-15 in FIG. 4A include two types of data (one type corresponding to data obtained during detection of an abnormality and the other type corresponding to data obtained when the abnormality is recovered). Further, the data items 1-8 in FIG. 4A constitute a warning group. The data items 9-15 constitute a protection detection group. The data items in FIG. 4A are recorded during detection of an abnormality and recovery of the abnormality.

The data items included in the log data of normal update (others) illustrated in FIG. 4B include, for example, “1. initial battery capacity”, “2. number of times of calculating initial battery capacity (number of times of learning)”, “3. initial internal resistance value”, “4. number of times of calculating resistance value (including number of times of learning)”, “5. capacity retention rate”, “6. number of times of re-charge”, “7. number of cycles of charge/discharge”, “8. charge amount below charge/discharge cycle”, “9. total charge time”, “10. total discharge time”, “11. absolute charge amount”, “12. maximum resistance value”, “13. latest resistance value”, “14. maximum difference resistance value”, “15. charge detection time”, “16. number of times of detecting charge”, and “number of times of detecting full-charge”. It is to be noted that the types or the order of the data items of the log data of normal update (others) are not limited to those illustrated in FIG. 4B.

Further, each of the data items 2, 4, 6, 7, 16, and 17 is incremented 1 level whenever a corresponding log is updated normally.

The data items included in the log data of abnormal detection (recovery) and the log data of normal update are recorded in the rewritable non-volatile memory 122 by using 7 pages of data-flash of the rewritable non-volatile memory 122, that is, a total data capacity of approximately 7168 bytes of the rewritable non-volatile memory 122 in a case where 1 page of the data flash of the rewritable non-volatile memory 122 is approximately 1024 bytes. In this embodiment, plural storage areas are provided in the rewritable non-volatile memory 122 so that one or more of the above-described data items of the log data can be recorded in the plural storage areas of the rewritable non-volatile memory 122.

For example, the past 6 recordings (including recording of highest value recorded in the past) of the log data of abnormal detection (recovery) may be stored (retained) as the history of log data. Further, the latest recording of the log data of normal update may be stored (retained) as the history of log data. Thereby, the protection module 100 according to an embodiment of the present invention can manage, for example, the status (e.g., degradation degree) of the secondary battery 200 by using the log data.

As illustrated in FIG. 5, one or more data items may be stored as the log data of normal update in correspondence with a timing that is determined beforehand. In this embodiment, plural groups of log data are provided in correspondence with the type of data item to be updated in a case of performing normal update.

For example, as illustrated in FIG. 5, in a case where the status of the secondary battery 200 is “charge/discharge”, the log data items “absolute charge amount”, “total charge”, and “total discharge time” are recorded as a single group (log data group). Further, in a case where the status of the secondary battery 200 is “immediately after charging”, the log data items “number of times of detecting charge” and “time of detecting charge” are recorded as a single group (log data group).

Further, in a case where the status of the secondary battery 200 is “after charge detection 1”, the log data items “number of times of recharge”, “number of times of calculating resistance value”, and “initial resistance value” are recorded as a single group. In a case where the status of the secondary battery 200 is “after charge detection 2”, the log data items “maximum difference resistance value”, “maximum resistance value”, and “latest resistance value” are recorded as a single group. In a case where the status of the secondary battery 200 is “charge complete”, the log data items “number of times of detecting full-charge”, “number of cycles of charge/discharge”, and “charge amount below charge/discharge cycle” are recorded as a single group.

In a case where the status of the secondary battery 200 is “predetermined time after charge”, the log data items “capacity retention rate”, “initial battery capacity”, and “number of times of learning initial battery capacity” are recorded as a single group. It is to be noted that the types of the log data group are not limited to those described above. Although recovery of log data can be performed in units of data items, it is preferable to recover the log data in units of log data groups because the content of the log data items included in the log data groups are related to one another. Further, a group(s) that includes a combination of the log data groups may also be provided.

According to an embodiment of the present invention, the protection module 100 records abnormal detection log data as a single block of 16 bytes and records normal update log data as a single block of 8 bytes. For example, a header may be allocated at the starting (top) 1 byte of each log data. The header of the log data may be identified (categorized) as, for example, “valid log”, “invalid log”, “unwritten log”, or “failure log”. The type of block may also be determined based on the header of the log data. According to an embodiment of the present invention, the abnormal detection log data and the normal update log data are separately recorded with respect to each page of the rewritable non-volatile memory 122.

The starting (top) 16 bytes of each page of the rewritable non-volatile memory 122 may be used as a page status block that retains data pertaining to the status of a page of the rewritable non-volatile memory 122. For example, the page status block may retain data pertaining to a determination result of a page of the rewritable non-volatile memory 122 (e.g., “unwritten”, “writing complete”, “middle of writing”), the type of log data written in a page of the rewritable non-volatile memory 122 (e.g., “abnormality detection”, the number of valid log data (only for a case of abnormality detection), or the number of times of erasing a page of the rewritable non-volatile memory 122.

Further, in a case of writing new data according to an embodiment of the present invention, the writing may be performed in accordance with an address indicated by a predetermined pointer (e.g., “abnormality detection header pointer”, “normal update header pointer”). Further, the number of times of writing a given log data item may be counted so that the log data item may be determined as log data no longer to be managed (invalid log data) in a case where the log data item is rewritten for more than a predetermined number of times.

### <Log Writing Format>

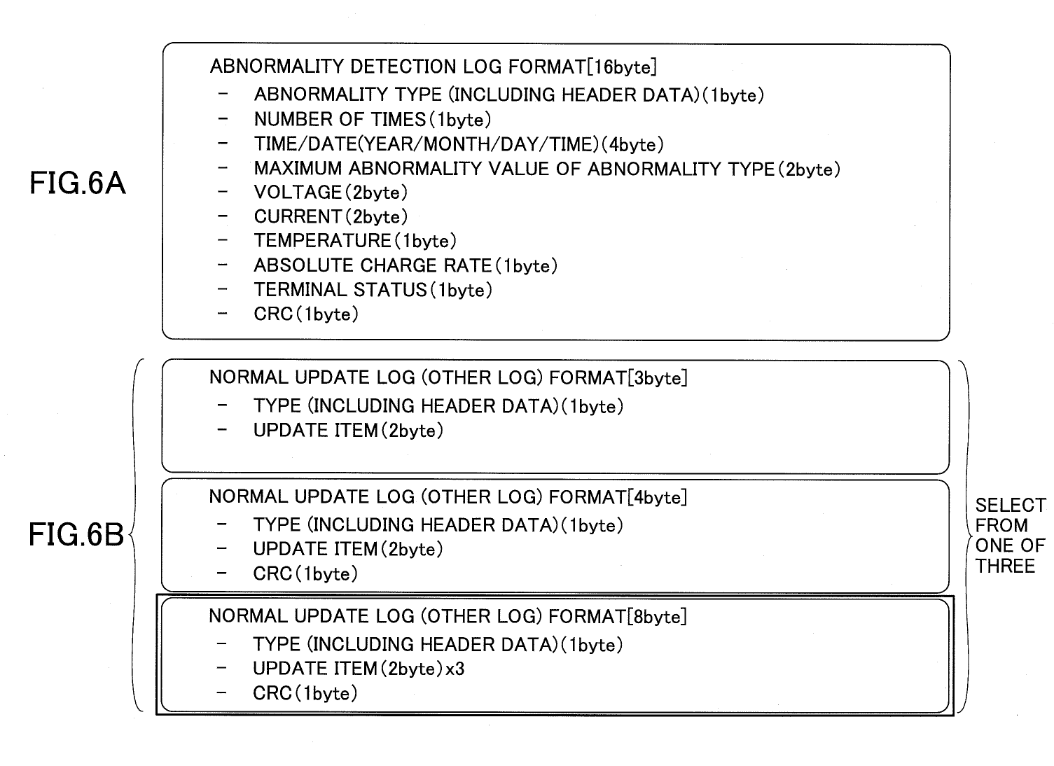

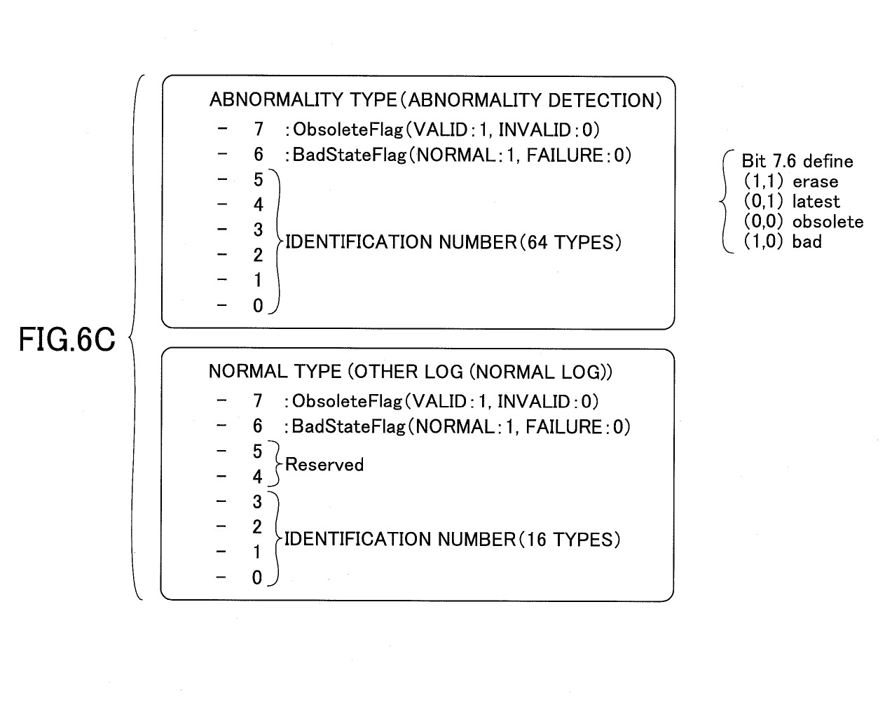

Next, a log writing format according to an embodiment of the present invention is described with reference to FIGS. 6A and 6B. FIGS. 6A and 6B are schematic diagrams for describing the log writing format according to an embodiment of the present invention. FIG. 6A illustrates an example of an abnormality detection log format according to an embodiment of the present invention. FIG. 6B illustrates an example of a normal update format according to an embodiment of the present invention.

In a case of the abnormality detection log format illustrated in FIG. 6A, data items such as “abnormality type (including header data) (1 byte)”, “number of times (1 byte)”, “time/date (year/month/day/time) (4 bytes)”, “maximum abnormality value of abnormality type (2 bytes)” “voltage (2 bytes)”, “current (2 bytes)”, “temperature (1 byte)”, “absolute charge rate (1 byte)”, “terminal data (1 byte)”, and “CRC (Cyclic Redundancy Check) (1 byte)” are stored as log data when abnormality is detected

In a case of the normal update log format illustrated in FIG. 6B, log data is generated based on one format selected from three types of formats (a first format of 3 bytes, a second format of 4 bytes, and a third format of 8 bytes). The first format includes a type of format (including header data) (1 byte) and an update item (2 bytes). The second format includes a type of format (including header data) (1 bytes), an update item (2 bytes), and a CRC (1 byte). The third format includes a type of format (including header data) (1 byte), 3 update items (2 bytes×3), and a CRC. The third format can store 3 times more update items compared to the second format.

FIG. 6C illustrates flag data of an abnormality type (abnormality detection) format and flag data of a normal type (other log data (normal log data)) format. In other words, flag data for identifying the area in which the latest (newest) data is stored is set with respect to the abnormality type format and the normal type format. The latest data corresponding to each data item can be obtained at the time of recovery by referring to the flag data of the abnormality type format and the flag data of the normal type format.

In the example illustrated in FIG. 6C, data value “0xFF” indicates a block that is already erased, and an identification number indicates a block that is to be registered. Further, in the example illustrated in FIG. 6C, “ObsoleteFlag” is for indicating whether a corresponding block is valid or invalid, and “BadStateFlag” is for indicating whether a corresponding block is normal or abnormal (failure).

By setting the above-described flag data at the time of generating log data, even in a case where data is erased during a log updating process due to, for example, disconnection, the latest data immediately before the disconnection can be obtained. As a result, a highly accurate recovery process can be performed.

<Example of Transition of Status in a Case where Log Data is Stored in Memory>

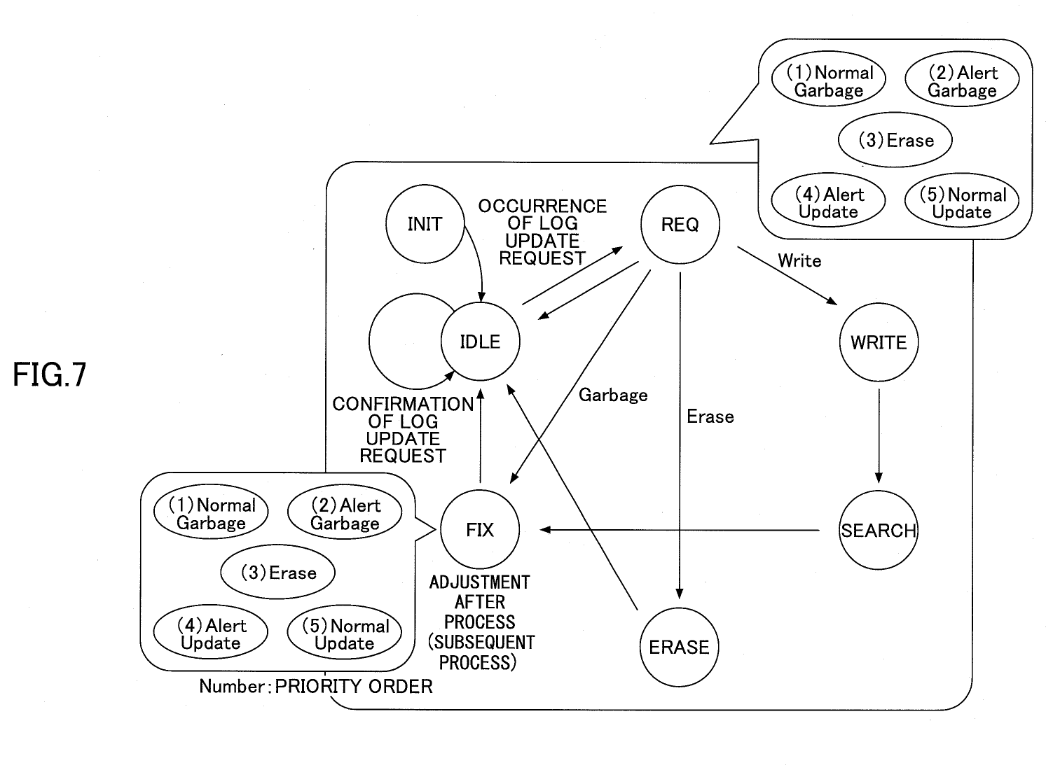

Next, an example of status transition in a case of storing log data in a memory is described with reference to FIG. 7.

In the example illustrated in FIG. 7, an operation of storing data in a memory includes 5 types of processes “(1) Normal Garbage”, “(2) Alert Garbage”, “(3) Erase”, “(4) Alert Update”, and “(5) Normal Update”. It is, however, to be noted that the operation of storing data is not limited to the example illustrated in FIG. 7.

First, processes such as defining of an abnormality detection head pointer and a normal update header pointer, reading out of normal update log data, and handling of abrupt reset are performed as an initialization (INIT) process. Further, a log service task, which is normally in an idle (IDLE) state, stands by until there is a request to start the log service task. In a case where such request (REQ) is accepted (occurrence of log update request), processes such as writing (WRITE), searching (SEARCH), and post-processing (FIX), and erasing (ERASE) are performed.

Because writing/reading of data cannot be performed during erasing of data of a flash memory (rewritable non-volatile memory 122), a log updating/reading process is in a standby state during the erasing process. Requests of the log module can be broadly categorized into, for example, an “erase process request”, a “save (garbage collection request)”, and a “log update request”.

In a case where there is an occurrence of a request to update a normal update log, the header and CRC-8 of a log block (log data) to be updated is updated, and writing is performed on the log block from the header pointer. After the writing of data, the previous recorded log is changed into an invalid log. In a case where there is an occurrence of a request to update an abnormality detection log, a value to be updated is selected to be stored in a shared temporary cache. Then, writing is performed on a log block from the header pointer. In a case where the number of log data items that are recorded are, e.g., equal to or more than 6, the oldest log (except for the log having highest value) is changed to an invalid log. In a case where a normal update log makes a transition to a new page, re-writing (garbage collection) is performed on a valid normal update log that is recorded in another page. Thereby, a valid log other than the page that is currently written is eliminated.

### <Usage/Purpose of Log and Determining Validity of Data>

Next, the usage/purpose of log data and the determining of validity of data are described according to an embodiment of the present invention. For example, an erased block (0xFF) or a valid recorded block (CRC-OK) is checked when performing POR (Power On Reset). Then, in a case where an erased block or a valid recorded block is found by the check, the found block is changed into an invalid block.

In a case of updating a normal update log (e.g., capacity retention rate, resistance value), a previously recorded log (log recorded before the latest recording) is changed into an invalid log after the latest log is confirmed to be recorded normally (i.e. without any abnormality). Therefore, among the logs remaining after the check during POR, the log that is recorded last is used as an initial value (the latest value). The abnormality detection log (e.g., high temperature warning) is used as a valid log only with respect to the logs remaining after the check.

Further, with the above-described embodiment of the present invention, in a case where there is a request to read out log data from an external terminal via the communication part 143, a corresponding log recorded in the rewritable non-volatile memory (flash memory) 122 is searched and sent as valid log data to the external terminal after finding the corresponding log and performing CRC on the found log data. Further, by preparing software operating in a PC (Personal Computer) for analyzing the content of all of the data stored in the rewritable non-volatile memory (flash memory) 122, the software can function as a flight recorder or the like.

### <Flowchart of Managing Status Data>

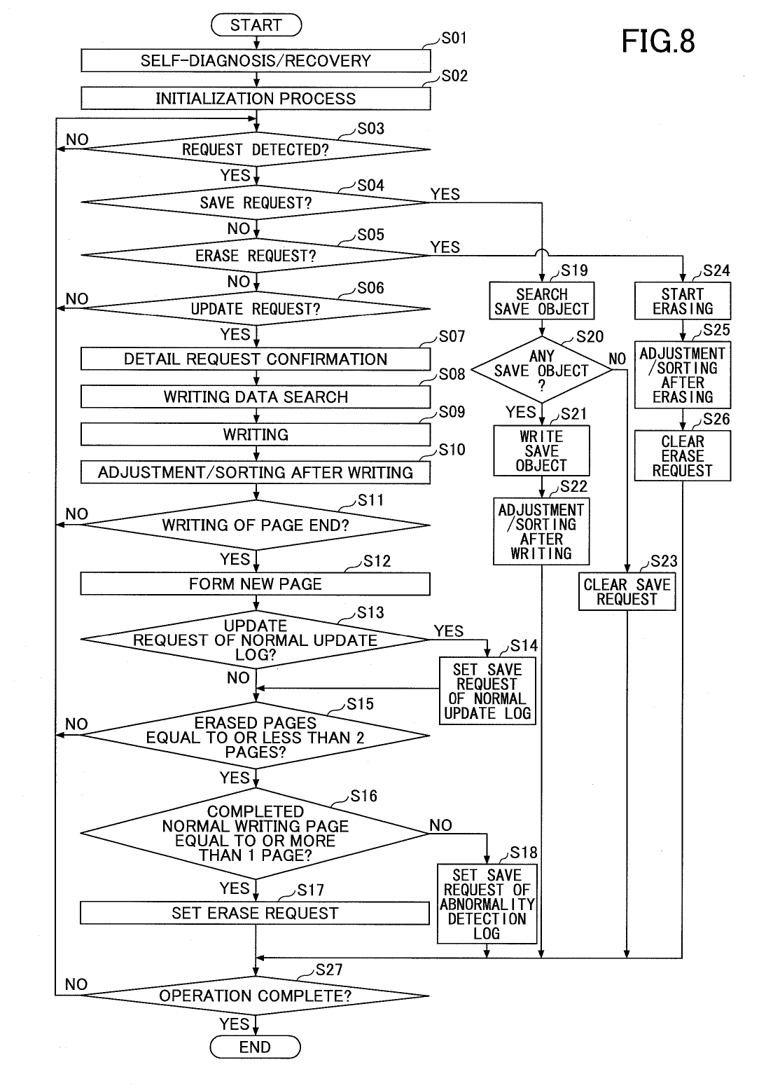

Next, a flowchart illustrating an operation for managing status data during a log data (history data) storage process according to an embodiment of the present invention is described. FIG. 8 is a flowchart illustrating an example of an operation for managing status data according to an embodiment of the present invention.

First, in the status data managing operation illustrated in FIG. 8, self-diagnosis/recovery of a data flash of the rewritable non-volatile memory (flash memory) 122 is performed (Step S01). Then, an initialization process of the rewritable non-volatile memory (flash memory) 122 is performed (Step S02).

Then, it is determined whether there is any request to log data (Step S03). In a case where no request is detected (No in Step S03), a log updating/reading process is in a standby state. In a case where a request is detected (Yes in Step S03), it is determined whether the request is a request to save (garbage collection) log data (abnormality detection log or normal update log) (Step S04). In a case where the detected request is not a request to save log data (No in Step S04), it is determined whether the detected request is a request to erase log data (Step S05). In a case where the detected request is not a request to erase log data (No in Step S05), it is determined whether the detected request is a request to update log data (Step S06).

In a case where the detected request is to update log data (Yes in Step S06), details of the request is confirmed (Step S07). Then, data written in the rewritable non-volatile memory (flash memory) 122 is searched (Step S08). Then, written data obtained by the search is written as log data (Step S09). Then, adjustment/sorting of memory capacity, memory address, and flags is performed after the writing of the log data (Step S10).

Then, it is determined whether the writing of Step S09 has reached an end of a page (page end) of the rewritable non-volatile memory (flash memory) 122 (Step S11). In a case where the writing of data has reached the page end (Yes in Step S11), a new page is formed in the rewritable non-volatile memory (flash memory) 122.

Then, it is determined whether the update request is a request to update a normal update log (Step S13). In a case where the update request is a request to update a normal update log (Yes in Step S13), a request to save the normal update log is set (Step S14). After Step S14 or when the update request is not a request to update a normal update log (No in Step S13), it is determined whether an erased page is equal to or less than a predetermined number of pages (e.g., 2 pages) (Step S15). In a case where 2 or less pages are erased (Yes in Step S15), it is determined whether a normally written completed page is equal to or more than a predetermined number of pages (e.g., 1 page) (Step S16). In a case where there are 1 or more normally written completed pages (Yes in Step S16), a request to erase log data is set (Step S17). In a case where there is less than one normally written completed pages (No in Step S16), a request to save an abnormality detection log is set (Step S18).

In the case where the detected request is a save request in Step S04 (Yes in Step S04), a target to be saved is searched (Step S19). Then, it is determined whether there is any target to save (Step S20). In a case where there is a target to be saved (Yes in Step S20), the target to be saved is written in the rewritable non-volatile memory (flash memory) 122 (Step S21). Then, adjustment/sorting of memory capacity and the like is performed (Step S22). In a case where there is no target to be saved (No in Step S20), the save request is cleared (Step S23).

In the case where the detected request is an erase request (Yes in Step S05), erasing of log data is started (Step S24). After the erasing in Step S24 is completed, adjustment/sorting of memory capacity and the like is performed (Step S25). Then, the erase request is cleared (Step S26).

After the performing the processes in Steps S17, S18, S22, S23, or S26, it is determined the entire operation is completed (Step 27). In a case where the operation is not complete (No in Step S27), the operation returns to Step S03 to perform the processes following Step S03. In a case where it is determined that the entire operation is completed (finished) (Yes in Step S27), the status data managing operation is terminated. Further, in a case where the detected request is not a request to update log data (No in Step S06), a case where the writing of data has not reached the page end (No in Step S11), or a case where 2 or less pages are not erased (No in Step S15), the operation returns to Step S03 to perform the processes following Step S03.

With the protection module and the method for managing status data of the protection module according to the above-described embodiment of the present invention, status data of a secondary battery can be more reliable and managed with greater accuracy. Further, with the protection module and the method for managing status data of the protection module according to the above-described embodiment of the present invention, even in a case where data is destroyed when recording the data to a rewritable non-volatile memory (flash memory) of the protection module, the data can be recovered. Thereby, a more reliable system can be built.

Further, the present invention is not limited to these embodiments, but variations and modifications may be made without departing from the scope of the present invention.

The present application is based on Japanese Priority Application No. 2011-029139 filed on Feb. 14, 2011, with the Japanese Patent Office, the entire contents of which are hereby incorporated by reference.

What is claimed is:

1. A protection module interposed between a chargeable/dischargeable secondary battery and a load, the protection module comprising:
a first switching element connected to the chargeable/dischargeable secondary battery;
a second switching element connected to the load;
a protection unit configured to prevent over-charge and over-discharge of the chargeable/dischargeable secondary battery by switching on/off the first and the second switching elements;
a storage unit configured to store status data of the chargeable/dischargeable secondary battery and threshold data pertaining to a status of the chargeable/dischargeable secondary battery;
a status monitor unit configured to monitor the status of the chargeable/dischargeable secondary battery;
wherein the status monitor unit is configured to allocate a plurality of storage areas in the storage unit and store the status data and a flag data indicating whether the status data is a latest status data in one of the plural storage areas.

2. The protection module as claimed in claim 1, wherein the status monitor unit is configured to set the flag data with respect to a status item selected from a plurality of status items included in the status data.

3. The protection module as claimed in claim 2, wherein the selected status item includes a plurality of groups, wherein the status monitor unit is configured to set the flag data in correspondence with each group of the plural groups.

4. The protection module as claimed in claim 1, wherein the plural storage areas are three or more storage areas, wherein the status monitor unit is configured to obtain a degradation degree of the chargeable/dischargeable secondary battery based on chronological storage data obtained from the three or more storage areas.

5. A method for managing status data of a protection module interposed between a chargeable/dischargeable secondary battery and a load, the method comprising the steps of:
a) monitoring a status of the chargeable/dischargeable secondary battery; and
b) storing status data of the chargeable/dischargeable secondary battery in a storage unit of the protection module;
wherein the step a) includes allocating a plurality of storage areas in the storage unit; and
wherein the step b) includes storing the status data and a flag data indicating whether the status data is a latest status data in one of the plural storage areas.

6. The method as claimed in claim 5, the step a) further includes setting the flag data with respect to a status item selected from a plurality of status items included in the status data.

7. The method as claimed in claim 6, wherein the selected status item includes a plurality of groups, wherein the step a) further includes setting the flag data in correspondence with each group of the plural groups.

8. The method as claimed in claim 5, wherein the plural storage areas are three or more storage areas, wherein the step a) further includes obtaining a degradation degree of the chargeable/dischargeable secondary battery based on chronological storage data obtained from the three or more storage areas.
